(19) United States
(12) Patent Application Publication
(10) Pub. No.: US 2007/0235144 A1
(43) Pub. Date: Oct. 11, 2007

(54) Thermopressing device for fabricating a fuel cell

(76) Inventors: Tsang-Ming Chang, Taipei (TW); Wei-Li Huang, Taoyuan (TW); Yean-Der Kuan, Taichung (TW); Ching-Yi Chang, Banciao (TW); Chia-Hao Chang, Yunlin (TW); Min-Feng Sung, Taipei (TW)

Correspondence Address: G. LINK CO., LTD., 3550 Bell Road, Minooka, IL, 60447, US

(21) Appl. No.: 11/393,877

(22) Filed: Mar. 31, 2006

(51) Int. Cl. B30B 15/34; B32B 37/00; B32B 37/06; B32B 37/08; B30B 15/06

(52) U.S. Cl. 156/583.1; 100/295; 156/498; 156/359

(57) ABSTRACT

A thermopressing device for fabricating a fuel cell is disclosed. The thermopressing device comprises a first press plate, a first heating portion, one or more first hollow portions, a second press plate, a second heating portion, and one or more second hollow portions. The first heating portion is disposed on the first press plate. The first hollow portions are disposed on the first press plate and penetrate through the first press plate. The second heating portion is disposed on the second press plate. The second hollow portions are disposed on the second press plate and penetrate through the second press plate. The first heating portion and the second heating portion serve to supply heat sources.

### FIELD OF THE INVENTION

The present invention relates to a device for fabricating fuel cells, and more particularly, to a thermopressing device that presses multi layers of substrates with a thermal press, so as to form a fuel cell.

### BACKGROUND OF THE INVENTION

To fulfill thinned and miniaturized fuel cells, a novel fuel cell composed of plate-shaped substrates adhered with thermal press is developed. An exemplar of such fuel cells is a fuel cell fabricated by printed circuit board (PCB) processes. The method to form the cells using PCB processes includes performing a thermal press process to join several substrates together. Once the operational temperature is too high during the thermal press process, the membrane electrode assemblies (MEAs) of the fuel cell will be damaged. As such, manufacturers are obliged to use adhesives that can be processed at a relative low temperature. But usually, the low-temperature adhesives are not very sticky, resulting in the thermal pressed fuel cells peeling off easily. On the other hand, manufacturers will face the challenges of high-temperature effects on the MEAs if they utilize adhesive glue that is operated at a relative high temperature.

Therefore, a thermopressing device for manufacturing fuel cells is provided to overcome the aforementioned disadvantages.

### SUMMARY OF THE INVENTION

It is a primary object of the invention to provide a thermopressing device for fabricating fuel cells, which can prevent the membrane electrode assemblies of fuel cells from being damaged during a thermal pressing process.

In accordance with the aforesaid object of the invention, a thermopressing device for fabricating a fuel cell is provided, which is used to press a fuel cell device composed of multi layers of substrates. The thermopressing device comprises a first press plate, a first heating portion, one or more first hollow portions, a second press plate, a second heating portion, and one or more second hollow portions. The first heating portion is disposed inside the first press plate. The first hollow portions are disposed on the first press plate and penetrate through the first press plate. The second heating portion is disposed inside the second press plate. The second hollow portions are disposed on the second press plate and penetrate through the second press plate. The first heating portion and the second heating portion serve to supply heat sources.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is an exploded diagram showing the structure of a thermopressing device for fabricating fuel cells according to the first embodiment of the invention;

FIG. 2 illustrates the top view of a first pressing plate in accordance with the first embodiment of the invention;

FIG. 3 is an exploded diagram showing the structure of a thermopressing device for fabricating fuel cells according to the second embodiment of the invention;

FIG. 4 illustrates the top view of lower surface of a first pressing plate in accordance with the second embodiment of the invention; and

FIG. 5 illustrates the structure of associated elements disposed inside the hollow portion according to an embodiment of the invention.

### DETAILED DESCRIPTION OF THE INVENTION

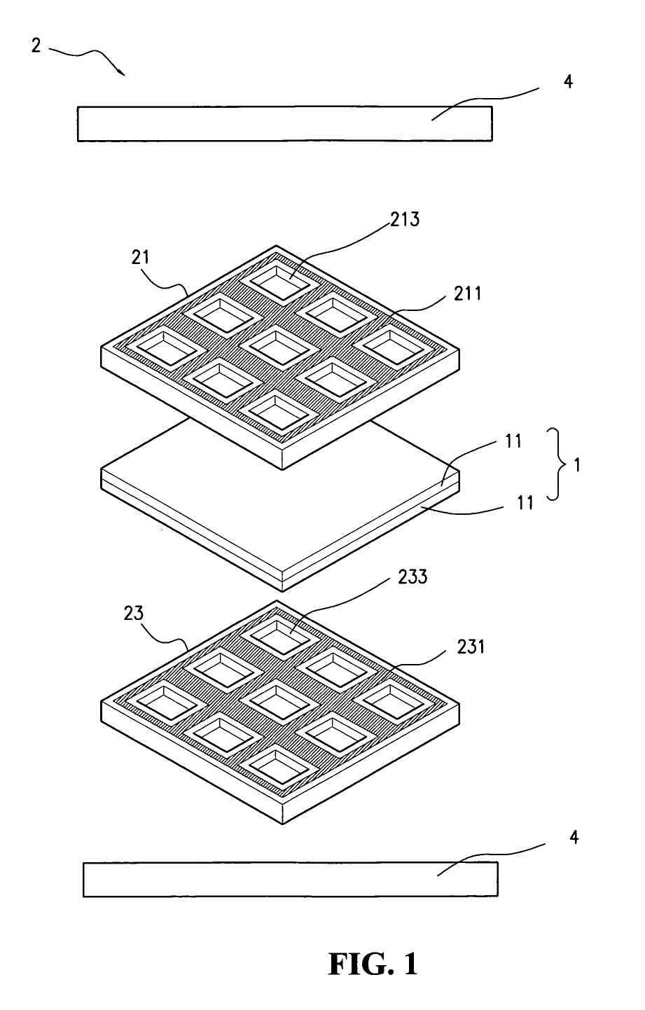

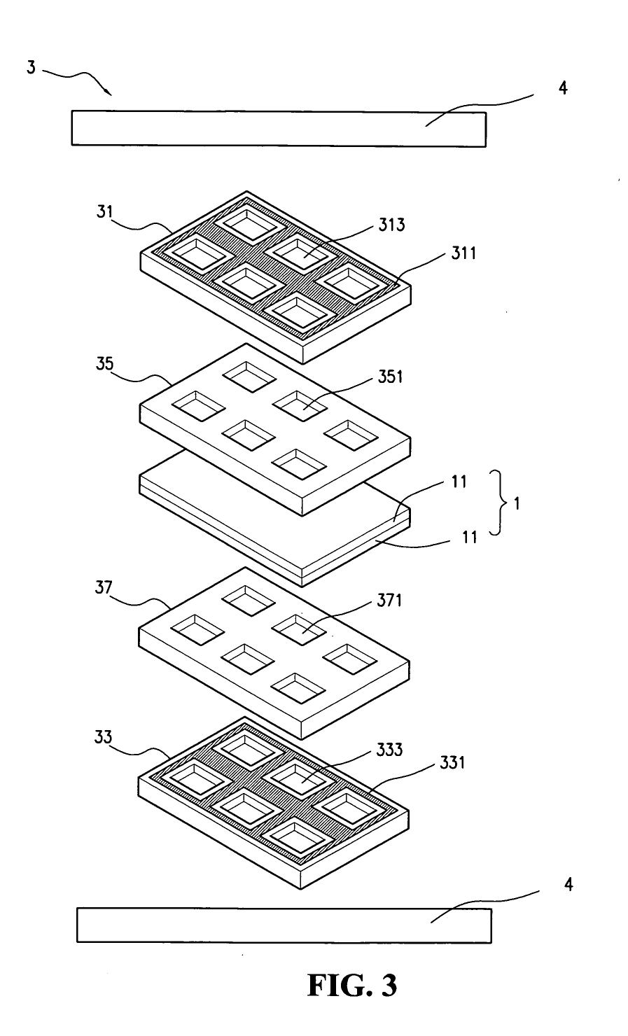

Referring to FIG. 1 and FIG. 3, the thermopressing devices 2, 3 are primarily provided for pressing a fuel cell device 1. The fuel cell device 1 is fabricated by stacking and pressing multi layers of substrates 11. An exemplar of the fuel cell device 1 may include a piece of direct methanol fuel cell (DMFC). The DMFC comprises two or more stacked layers of FR4 substrates 11 (or ceramic substrates, printed circuit substrates or polymer plastic substrates) before they are pressed. For example, the substrates 11 from bottom to top are a piece of bipolar fuel cell plate, a piece of two-sided flow plate and another piece of bipolar fuel cell plate, respectively. The substrates 11 are further pressed by the thermopressing devices 2, 3, so as to form a single piece of DMFC that is sealed.

FIG. 1 is an exploded diagram showing the structure of a thermopressing device for fabricating fuel cells according to the first embodiment of the invention. The thermopressing device 2 comprises a first press plate 21, a first heating portion 211, one more more first hollow portions 213, a second press plate 23, a second heating portion 231, and one or more second hollow portions 233, which are separately described hereinafter. The first press plate 21 may be a metallic plate. The first heating portion 211 is disposed inside the first press plate 21. The first hollow portions 213 are disposed on the first press plate 21, and penetrate through the first press plate 21. Since the membrane electrode assemblies (MEAs) of the fuel cell device 1 (not shown) are affected by heat easily, the first hollow portions 213 are disposed corresponding to the MEAs, respectively. Similarly, the structures of the second press plate 23, the second heating portion 231 and the second hollow portions 233 may have the same deployment as those of the first press plate 21, the first heating portion 211 and the first hollow portions 213. Furthermore, two surfaces where the first press plate 21 and the second press plate 23 face each other are individually shaped with respect to the upper and lower surfaces of the fuel cell device 1. The first press plate 21 and the second press plate 23 thus contact the fuel cell device 1 more evenly, which benefits the pressing process.

The first heating portion 211 and the second heating portion 231 serve as heat sources on the first press plate 21 and the second press plate 23, respectively, to heat the press plates 21, 23 and raise the temperatures thereof. The press plates 21, 23 separately contact the most outer top and bottom surfaces of the fuel cell device 1, and hence a heat source sufficient to fuse each substrate 11 is produced through temperature distribution. Meanwhile, the hollow portions 213, 223 are designed to protect the MEAs. The influence of heat generated from the first heating portion 211 and the second heating portion 231 on the MEAs is under control, and the damage to the MEAs is eliminated accordingly.

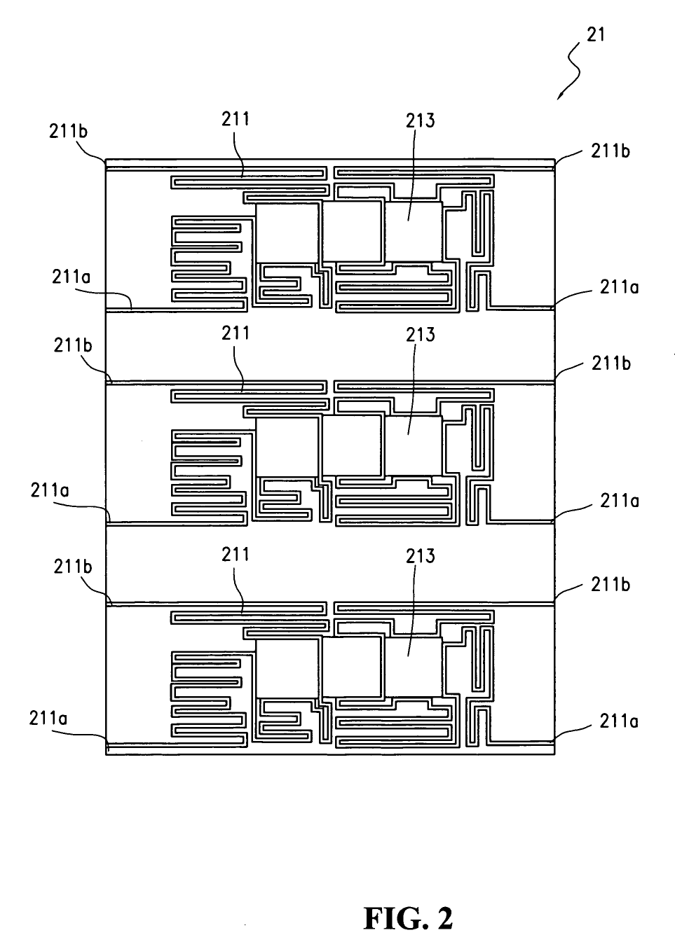

FIG. 2 illustrates the top view of a first pressing plate in accordance with the first embodiment of the invention. The first heating portion 211 is, for example, a heating channel. The heating channel may include a cannular structure bended within the first press plate 21, such as a water pipe. The cannular structure is used to direct a fluid with high temperature such that the fluid flows from an inlet 211a and flows out of an outlet 211b through the cannular structure of the first press plate 21. Similarly, the second press plate 23 may utilize the same structure as the first press plate 21 shown in FIG. 2. Another exemplar of the heating channel may include heating tubes like resistive-type heating tubes or other kinds of heating tubes.

FIG. 3 is an exploded diagram showing the structure of a thermopressing device for fabricating fuel cells according to the second embodiment of the invention. The thermopressing device 3 comprises a first press plate 31, a first heating portion 311, one or more first hollow portions 313, a first cap plate 35, a second press plate 33, a second heating portion 331, one or more second hollow portions 333, and a second cap plate 37, which are individually described hereinafter. The first press plate 31 may be a metallic plate. The first heating portion 311 is disposed on the lower surface of the first press plate 31. The first hollow portions 313 are disposed on the first press plate 31, and penetrate through the first press plate 31. The functions of the first heating portion 311 and the first hollow portions 313 are identical to those described in the first embodiment, and will not be stated again. Because the first heating portion 311 is positioned on the surface of the first press plate 31, the first heating portion 311 is exposed outside. The first cap plate 35 is chiefly used to cover the lower surface of the first press plate 31, and also to enclose the first heating portion 311. The first press plate 31 and the first cap plate 35 are connected with each other through, for example, screws, soldering, adhering using metallic glue, or other connecting methods that combine the above means. The second press plate 33, the second heating portion 331, the second hollow portions 333, and the second cap plate 37 may be designed straightly according to the first press plate 31, the first heating portion 311, the first hollow portions 313, and the first cap plate 35. The difference consists in that the second heating portion 331 is disposed on the upper surface of the second press plate 33, and the second cap plate 37 is used to cover the upper surface of the second press plate 33. The lower surface of the first press plate 31 faces the upper surface of the second press plate 33.

The hollow regions 351, 371 positioned on the first cap plate 35 and the second cap plate 37, respectively, are disposed corresponding to the hollow portions 313, 333. The first cap plate 35 and the second cap plate 37 may be metallic plates.

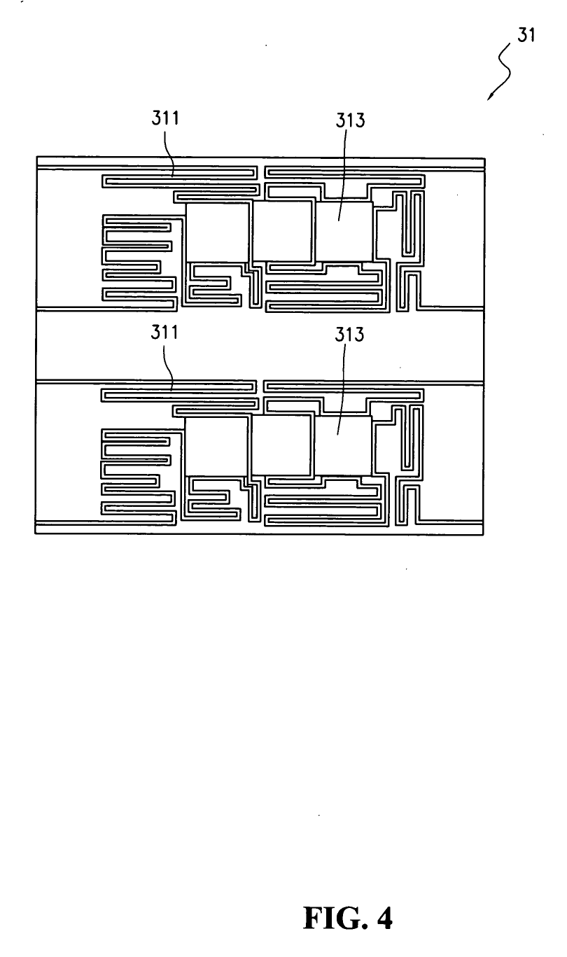

FIG. 4 illustrates the top view of the lower surface of a first pressing plate in accordance with the second embodiment of the invention. The first heating portion 311 is, for example, a heating channel. The heating channel may include a trench structure bended on the lower surface of the first press plate 31, such as a ditch. As the first cap plate 35 covers the lower surface of the first press plate 31, the trench structure is able to guide a fluid with high temperature. The purpose of guiding the high-temperature fluid is identical to that in the first embodiment. Similarly, a trench structure deployed on the upper surface of the second press plate 33 is used to direct a high-temperature fluid as well. Another exemplar of the heating channel may include heating tubes like resistive-type heating tubes or other kinds of heating tubes.

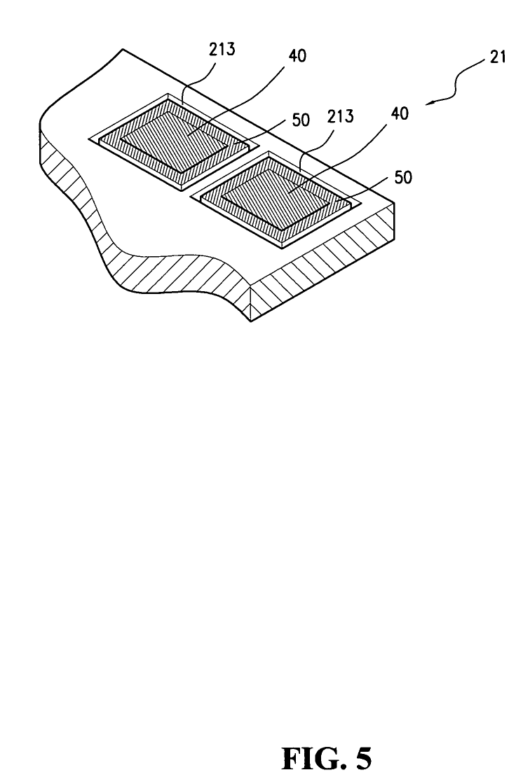

FIG. 5 illustrates the structure of associated elements disposed inside the hollow portion according to an embodiment of the invention. In the first and second embodiments, each hollow portion 213, 233, 313, 333 may further comprise a cooling component 40 therein. The cooling component 40 is provided for radiating heat out of the hollow portions 213, 233, 313, 333, so as to prevent the MEAs from being damaged due to high temperature during pressing. Moreover, each hollow portion 213, 233, 313, 333 may comprise an insulator 50 disposed around the sidewall thereof. Because the insulator 50 is characterized by a bad heat conductor, it avoids heat conducting among the hollow portions 213, 233, 313, 333 and the corresponding press plates 21, 23, 31, 33.

An exemplar of the cooling device 40 may include a radiator that can conduct heat by convention, conduction or radiation, such as a fan, an air pump, a heat pipe, a radiating fin, a block of heat conductor, a liquid cooling system, and so forth.

Regarding to the thermopressing devices 2, 3, after the substrates 11 of the fuel cell device 1 are stacked and pressed by thermopressing devices 2, 3, the stacked substrates 11 are positioned between the first press plate 21 and the second press plate 22 of the thermopressing device 2, or between the first cap plate 35 and the second cap plate 37 of the thermopressing device 3. The heating portions 211, 231, 311, 331 may introduce heat, and preferably introduce hot oil at high temperature. As a result, glue among the substrates 11 is softened and becomes adhesive, through which the substrates 11 are connected to one another. Additionally, an oil pressure device 4 is applied a force to the first press plates 21, 31 and the second press plates 23, 33 of the thermopressing devices 2, 3 as shown in FIG. 1 and FIG. 3, in order to push the first press plates 21, 31 and the second press plates 23, 33 mutually and to compact the substrates 11 such that the substrates 11 are jointed together more tightly.

In one aspect, when thermal pressing the substrates 11, a plurality of temperature sensors (not shown) like thermal couples are further disposed above the first press plates 21, 31 and the second press plates 23, 33 adequately for protecting the MEAs of the fuel cell device 1 and for controlling the temperature distribution over the heat source produced by the thermopressing devices 2, 3.

In another aspect, the thermopressing devices 2, 3 are also connected to a controller (not shown), e.g. a programmable controller or a computer, for controlling the progress of thermal pressing the substrates. The controller receives and determines a temperature signal from the temperature sensor, and then adjusts the operational temperature within the thermopressing devices 2, 3 until an optimal quantity of heat is supplied.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and detail may be made therein without departing from the spirit and scope of the invention, as set forth in the following claims.

What is claimed is:

1. A thermopressing device for fabricating a fuel cell, the thermopressing device is used to press a fuel cell device composed of multi layers of substrates, the thermopressing device comprising:
a first press plate;
a first heating portion disposed inside the first press plate;
at least one first hollow portion disposed on the first press plate and penetrating through the first press plate;
a second press plate;
a second heating portion disposed inside the second press plate; and
at least one second hollow portion disposed on the second press plate and penetrating through the second press plate;
wherein the first heating portion and the second heating portion supply heat sources.

2. The thermopressing device of claim 1, wherein the first heating portion is a heating channel bended within the first press plate, and the second heating portion is a heating channel bended within the second press plate.

3. The thermopressing device of claim 2, wherein the heating channel is a heating tube.

4. The thermopressing device of claim 2, wherein the heating channel comprises a cannular structure to direct a high-temperature fluid.

5. The thermopressing device of claim 1, further comprising a cooling component disposed on the first hollow portion.

6. The thermopressing device of claim 1, further comprising a cooling component disposed on the second hollow portion.

7. The thermopressing device of claim 5, wherein the cooling component is selected from a group consisting of a fan, an air pump, a heat pipe, a radiating fin, a block of heat conductor, and a liquid cooling system.

8. The thermopressing device of claim 6, wherein the cooling component is selected from a group consisting of a fan, an air pump, a heat pipe, a radiating fin, a block of heat conductor, and a liquid cooling system.

9. The thermopressing device of claim 1, further comprising an insulator disposed around a sidewall of the first hollow portion.

10. The thermopressing device of claim 1, further comprising an insulator disposed around a sidewall of the second hollow portion.

11. The thermopressing device of claim 1, further comprising an oil pressure device applying a force to the first press plate and the second press plate, respectively.

12. The thermopressing device of claim 1, further comprising a plurality of temperature sensors separately disposed on the first press plate and the second press plate for detecting temperatures of the first heating portion and the second heating portion.

13. A thermopressing device for fabricating a fuel cell, the thermopressing device is used to press a fuel cell device composed of multi layers of substrates, the thermopressing device comprising:
a first press plate;
a first heating portion disposed on a lower surface the first press plate;
at least one first hollow portion disposed on the first press plate and penetrating through the first press plate;
a first cap plate covering the lower surface the first press plate;
a second press plate;
a second heating portion disposed on an upper surface of the second press plate,
wherein the upper surface of the second press plate faces the lower surface of the first press plate;
at least one second hollow portion disposed on the second press plate and penetrating through the second press plate; and
a second cap plate covering the upper surface of the second press plate;
wherein the first heating portion and the second heating portion supply heat sources.

14. The thermopressing device of claim 13, wherein the first heating portion comprises a trench structure bended on the lower surface the first press plate, and the trench structure guides a high-temperature fluid.

15. The thermopressing device of claim 13, wherein the second heating portion comprises a trench structure bended on the upper surface the second press plate, and the trench structure guides a high-temperature fluid.

16. The thermopressing device of claim 13, further comprising a cooling component disposed on the first hollow portion.

17. The thermopressing device of claim 13, further comprising a cooling component disposed on the second hollow portion.

18. The thermopressing device of claim 16, wherein the cooling component is selected from a group consisting of a fan, an air pump, a heat pipe, a radiating fin, a block of heat conductor, and a liquid cooling system.

19. The thermopressing device of claim 17, wherein the cooling component is selected from a group consisting of a fan, an air pump, a heat pipe, a radiating fin, a block of heat conductor, and a liquid cooling system.

20. The thermopressing device of claim 13, further comprising an insulator disposed around a sidewall of the first hollow portion.

21. The thermopressing device of claim 13, further comprising an insulator disposed around a sidewall of the second hollow portion.

22. The thermopressing device of claim 13, further comprising an oil pressure device applying a force to the first press plate and the second press plate, respectively.

23. The thermopressing device of claim 13, further comprising a plurality of temperature sensors separately disposed on the first press plate and the second press plate for detecting temperatures of the first heating portion and the second heating portion.
